(19) United States
(12) Patent Application Publication
(10) Pub. No.: US 2007/0002866 A1
(43) Pub. Date: Jan. 4, 2007

(54) Receive power priority flooding in mobile ad hoc networks

(75) Inventors: John M. Belstner, Valley Center, CA (US); Jason F. Hunzinger, Escondido, CA (US)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/170,674

(22) Filed: Jun. 29, 2005

(51) Int. Cl. H04L 12/56

(52) U.S. Cl. 370/395.4

(57) ABSTRACT

An improved method is provided for disseminating information in an ad hoc wireless network. The method includes: receiving an incoming message at a recipient node of the network; scheduling a retransmission of the message, where the schedule time for the retransmission is proportional to a signal strength at which the message was received by the recipient node; and canceling the retransmission of the message when the same message is received from a different node in the network prior to the schedule time for the retransmission. The effect is reduced network traffic on the network with minimized latency.

### FIELD OF THE INVENTION

The present invention relates to mobile ad hoc networks and, more particularly, to a routing algorithm that reduces the latency and contention inherent to high-density flooding scenarios while increasing reliability of delivery and channel capacity.

### BACKGROUND OF THE INVENTION

Wireless communication between vehicles is a concept that is growing in interest among automobile manufacturers. Possible applications go beyond the obvious entertainment and Internet connectivity uses that are so widely publicized; they have the potential to enhance vehicle safety in a way that approaches the reliability and complexity of commercial avionics.

Traffic safety organizations such as the Vehicle Safety Communications Consortium (VSCC), the Federal Highway Administration (US DOT FHWA), and ISO (TC204 WG16) have identified high priority applications such as traffic signal violation warnings, left turn assistance, cooperative forward collision warnings and emergency electronic brake light signaling. For these applications to function properly, however, the necessary vehicles must receive certain essential data in a reliable and timely manner; these are characteristics that cellular and other infrastructure based communication methods cannot guarantee. Ad hoc networking can provide the reliable, low latency and high capacity communication paths necessary to make these applications feasible.

Ad hoc networking is not without its set of challenges, however. Choice of routing protocol (either directed or broadcast), contention mitigation, synchronization and latency reduction are among the design considerations. For several of the applications mentioned in the previous paragraph, the use of flooding as a routing protocol could be the best choice for extending the range of broadcast given the nature of the information and its application. It has been, however, largely ignored because of its shortcomings.

Flooding has two main challenges in mobile ad hoc networks involving automobiles: (i) insufficient radio range due to sparse networks as a result of sparse traffic or low availability of equipped vehicles and (ii) wireless medium contention due to high densities of vehicles. While sparse vehicle populations are common, many safety-related situations (e.g. collisions) occur under high vehicle density conditions such as rush hour traffic, busy intersections or crowded parking lots. A collision or emergency braking message propagated down a highway using flooding under such high vehicle density conditions may result in latencies too high for the information in the message to be useful.

FIG. 1 illustrates the topology and network traffic that might be generated from a vehicle safety type emergency braking message. In simple flooding, all vehicles repeat every message once. This scheme, though robust, generates a lot of redundant traffic on the network. With each repetition of the message from the lead vehicle and each repeat from adjacent vehicles within range, the channel quickly fills and contention builds. This shortens the effective range due to interference and increases latency due to the increased number of required hops. Especially at lower data rates, the latency due to contention and increased back off can be drastic. Latency can grow to the point where it is no longer feasible to relay information in a time critical manner.

Vehicle safety applications that require the broadcast of continuous information have the potential to create situations of increasing contention over time, particularly in situations of high vehicle traffic density. Such applications may include electronic road signs, intersection assistance and approaching emergency vehicle warning. If flooded, the data from these applications can saturate the network resulting in consistently long latencies. As packets are continually introduced to the network they must all compete for the medium. Some are lost due to collision while the others wait their turn to be transmitted. This build-up does reach a steady state saturation point, but not until after latencies become much longer than desired.

Latency is not the only undesirable effect seen in this scenario. Packet loss due to contention can also be significant especially, at the larger packet sizes. One consequence of high packet loss in vehicle safety applications is the necessity to repeat information more than once to guarantee delivery. Repeating the information causes further traffic loading.

For vehicle safety applications, efficient and effective flooding should be robust to positioning requirements and contention and to a wide-range of radio propagation scenarios resulting from a wide variety of vehicle topologies. The optimal forwarder in one direction may be non-optimal or even unsatisfactory for forwarding of packets in another direction. These concerns serve as motivation for a prioritized and contention-free vehicle safety information dissemination method.

### SUMMARY OF THE INVENTION

In accordance with the present invention, a method is provided for disseminating information in an ad hoc wireless network. The method includes: receiving an incoming message at a recipient node of the network; scheduling a retransmission of the message, where the schedule time for the retransmission is proportional to a signal strength at which the message was received by the recipient node; and canceling the retransmission of the message when the same message is received from a different node in the network prior to the schedule time for the retransmission. The effect is reduced network traffic on the network with minimized latency.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a diagram illustrating network traffic in an exemplary mobile ad hoc network employing a convention flooding approach;

FIG. 2 is a diagram illustrating network traffic in an exemplary mobile ad hoc network according to the principles of the present invention; and

FIG. 3 is a flowchart of an exemplary software implementation of a routing protocol in accordance with the present invention;

FIGS. 4 and 5 are graphs comparing latency between a simple flooding algorithm and the dissemination method of the present invention;

FIGS. 6 and 7 are graphs comparing packet loss between a simple flooding algorithm and the dissemination method of the present invention; and

FIGS. 8 and 9 are graphs comparing channel loading between a simple flooding algorithm and the dissemination method of the present invention.

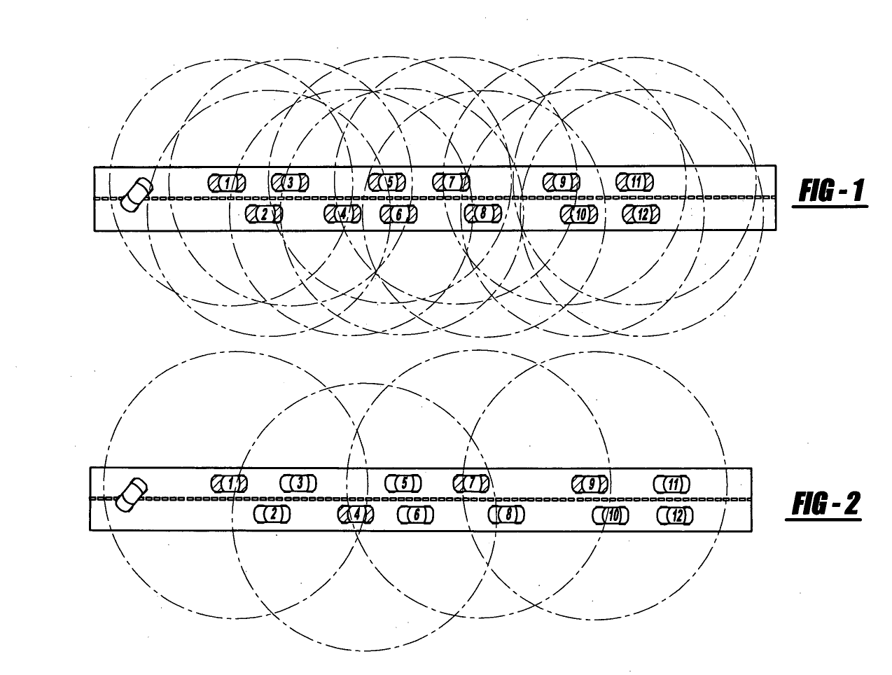

### DETAILED DESCRIPTION OF THE PREFERRED EMBODIMENTS

An improved method is proposed for disseminating information in an inter-vehicle communication network. In this exemplary application, vehicles are equipped to transmit and receive wireless RF transmissions amongst themselves as is known in the art. While the following description is provided with reference to inter-vehicle communication networks, it is readily understood that the broader aspects of the present invention are applicable to other types mobile ad hoc network environments. For instance, suitable environments may be found in military applications.

In simple flooding algorithms, each vehicle repeats each message at least once as described above. To reduce network traffic, only vehicles on the periphery of the transmission range for a given message needs to retransmit the message within the network. In other words, vehicles on the periphery of the transmission range are given priority to transmit first; whereas, vehicle within the periphery defer retransmitting the message for a longer period of time. Once a vehicle within the periphery receives the same message from another vehicle, it cancels any scheduled retransmission of the message. As transmission overlap is reduced, the amount of traffic on the channel is reduced as well as the contention and excessive latency it produces.

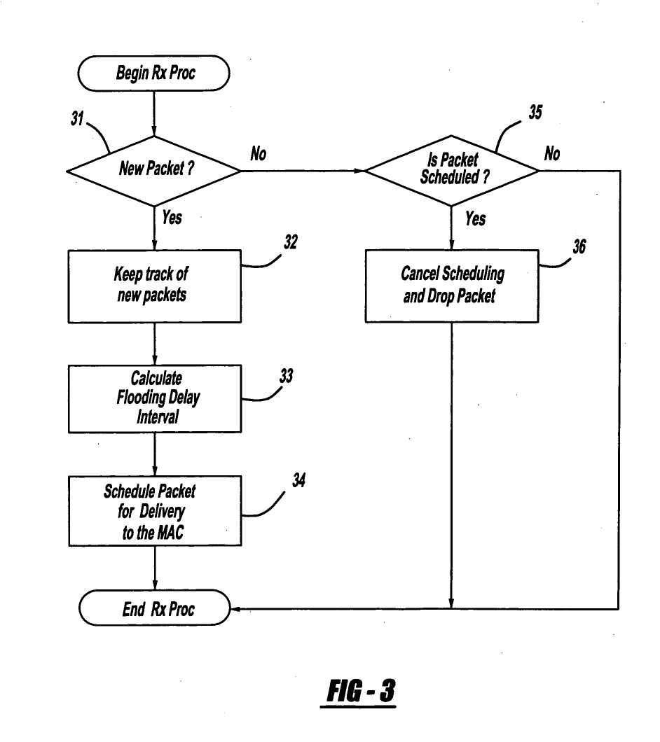

FIG. 2 illustrates the effect of this proposed routing protocol on network traffic in an exemplary inter-vehicle communication network. In contrast to conventional flooding approaches, the same area is covered with approximately one-third the number of vehicles transmitting. Only the shaded vehicles need to re-transmit the packet in order for the packet to propagate down the road. As the vehicle density increases, so does the ratio of unshaded vehicles to shaded vehicles. Given a fixed power, the number of vehicles transmitting on any given stretch of road would ideally remain constant regardless of the vehicle density. To minimize the number of hops, the maximum transmit power can be used without adverse affects because interference is limited by the fact that there are fewer transmissions

An exemplary software implementation of this proposed routing protocol is further described in relation to FIG. 3. It is to be understood that only the relevant steps of the protocol are discussed below, but that other software-implemented instructions may be needed to control and manage the overall operation of the system. In one embodiment, the routing protocol may be implemented as an agent residing above the 802.11 MAC layer of a wireless communication framework.

Upon receipt of a data packet (i.e., message), an assessment is made at 31 as to whether the same message has been received by this vehicle in the past. For new data packets, identifying information is extracted from the data packet and stored in a log as indicated at 32. It is readily understood that such identifying information will be used for subsequent assessments of arriving data packets.

A schedule time for retransmitting the data packet is determined at step 33. For example, priority may be given to vehicles that receive the data packet having the lowest signal strength above some minimum threshold value. Thus, each vehicle schedules retransmission of data packets at a time which is proportional to the signal strength at which the data packet was received by the recipient vehicle. The data packet is then scheduled at 34 for subsequent retransmission in the network.

In one exemplary embodiment, the schedule time is derived from the signal strength at which a data packet was received. For illustration purposes, the schedule time may be derived as follows:
i=(10×log(pᵣₓ)−10×log(pₘᵢₙ))xtₛ
where i is a delay period before scheduled retransmission, pᵣₓ is the power level at which the data packet was received, pₘᵢₙ is a minimum power level at which the data packet can be reliably received at, and tₛ is spacing time for transmitting data packets. The value of tₛ determines the delay spacing between packets of adjacent receive power levels and can be tailored for specific packet sizes to provide optimum latency. The value of tₛ may also be tailored to meet other system performance criteria.

In an alternative embodiment, the schedule time may be read from an empirically derived table as shown below.

| Power Level | Delay Time (ms) |
|---|---|
| pᵣₓ >= p₂ | 5 |
| p₂ > pᵣₓ >= p₁ | 3 |
| p₁ > pᵣₓ >= pₘᵢₙ | 1 |

In the table, each row corresponds to a range of signal strengths at which a data packet was received and correlates each range of signal strength to a unique schedule time. As described above, the schedule time increases as the range of signal strength increases. Schedule times are preferably selected based on a desired maximum hop time. Likewise, the spacing between the schedule times may be selected based on latency requirements as well as other system performance criteria.

To reduce message redundancy, the routing protocol continues to monitor incoming data packets. If the same data packet is received again before its scheduled retransmission, then the scheduled retransmission is cancelled as indicated at 36. Since the schedule time is proportional to the signal strength at which the data packet was received, the receipt of the duplicative data packet is likely to have been transmitted by a vehicle further away from the originating vehicle than the recipient vehicle, thereby negating the need for the recipient vehicle to retransmit the data packet within the network. If the same data packet is received after it has already been retransmitted, then this packet may be ignored as shown. A reference to the packet in the log is preferably kept for some time. The reason for this is to prevent retransmitting the same packet if it gets retransmitted, for example, by a vehicle that did not receive the packet that caused the cancellation.

Parameters should be selected to suit the latency requirements of the application and also the medium access environment. Because the forwarding mechanism is based on time delays, any medium delays may impact the operation of the invention. Thus, the maximum delay, which occurs when all vehicles receive the message at very high power, should be less than the application's required latency per-hop or latency per meter (i.e. range).

Furthermore, if the channel can be accessed for only a limited period of time, the forwarding algorithm should be configured to ensure forwarding well within the limited channel access window. For example, consider a situation where the channel used for forwarding the messages is subdivided into slots of 100 ms in duration. Suppose further than only every second slot is available for forwarding such safety messages. The algorithm should be configured so that the maximum delay should be considerably less than the slot duration. Otherwise, if no message is received before the termination of the slot, then it is possible that all vehicles' timers will expire by the beginning of the next available slot. As a result, all those vehicles will try to forward the packets at the same time (the beginning of the next available slot).

However, note the above problem does not occur if the slot duration is relatively small compared to the delays used by the algorithm (e.g. ts). This is due to the slots being negligible in duration relative to the timing. In summary, the delay values should either be substantially smaller than channel access windows or substantially larger.

Network simulations were used to analyze the performance of the algorithm and protocol. Simulations were conducted using the network simulator (ns2). The algorithms and protocols were implemented in the framework of a new routing agent above the 802.11 MAC and PHY. A two-ray fading model was used with unity gain omni directional antennas with a fixed transmit power of 125 mW.

The topology chosen for this study is a simulation of a one-kilometer stretch of a four-lane road with vehicles distributed along the one kilometer. Vehicle densities were chosen from data provided by the California Department of Transportation; each simulation had a unique average density ranging from 50 vehicles-per-minute (vpm) to 200 vehicles-per-minute at 100 kilometers-per-hour (kph). The intervals between vehicles varied constantly throughout the simulation according to a Poisson distribution with a minimum distance of half a vehicle length (2 meters) and a maximum distance of 10 times the average for that particular vehicle density.

The packet size and repetition rates of the flooding traffic used in these simulations were chosen to be consistent with the size and rates envisioned for future applications. Specifically, packet sizes of 1000, 500, 250 and 125 bytes were sent at intervals of 50 and 100 milliseconds. Data rates of 27 Mbps and 1 Mbps were used for comparison. Bursts of 200 and 2000 packets were used to simulate transient and steady state events.

The scenario chosen for simulation was an implementation of an emergency vehicle braking event. An obstruction at the head of the road forces the lead vehicle to quickly apply the brakes sending a broadcast emergency braking message down the road behind it.

The following data compares the performance of simple flooding to that of the dissemination method of the present invention. The criterion for comparison is latency, reliability and channel loading. The latency and reliability graphs illustrate the packet delay and packet loss as a function of the distance down the road from the packet source. Simulations were run at 1 Mbps, to allow for direct comparison to similar research, and 27 Mbps to observe benefits realized at one of the higher data rates suggested by DSRC.

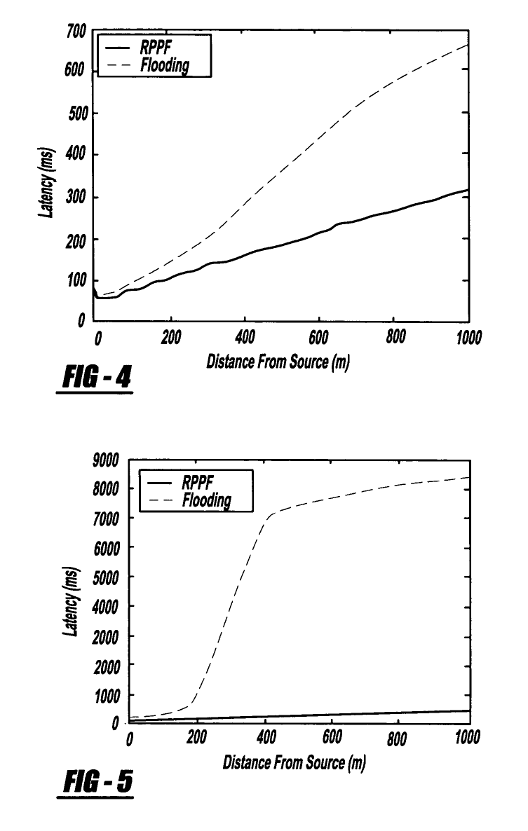

The simple flooding 27 Mbps packet delay shown in FIG. 4 may not appear all that long, even at 1 km (˜660 ms). But keep in mind these curves are only showing the response to a single event within a single application. Notice the simple flooding latency curve has a non-linearity that is indicative of increasing back off due to contention. The same scenario using the routing technique of the present invention shows the packets make it to the 1 km point in less than half the time.

At 1 Mbps, the reduction in contention offered by the algorithm of the present invention is clearly shown in FIG. 5. The 1 km latency time drops from nearly 8.5 seconds to less than 450 milliseconds. Such a reduction in latency may make the use of a 1 Mbps data rate viable.

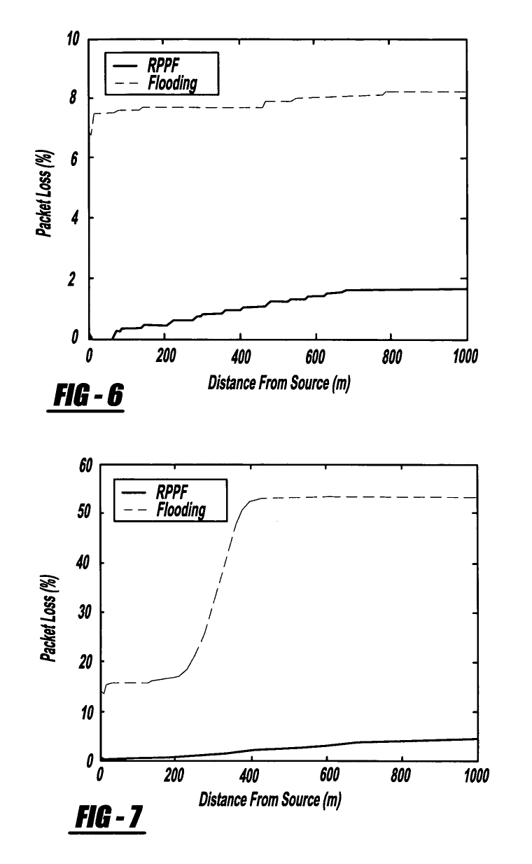

The simple flooding 27 Mbps packet for loss data shown in FIG. 6 at 1 km is approximately 8%. These graphs show the impact of a single event within a single application. The improvement using the dissemination method of the present invention is noteworthy, dropping the 1 km packet loss from 8% to less than 1.6%.

The same simulations were run at 1 Mbps to illustrate the performance of the dissemination method in heavy contention; the results are shown in FIG. 7. Packet loss at the 1 km point is extremely high in the simple flooding case (over 50%); whereas, using the present invention, the packet loss drops to 4%.

The channel loading characteristics at 27 Mbps were collected from a simulation that sends 1 k-byte packets every 100 ms for 20 seconds. The source vehicle is at the head of a 125-vehicle line. The average length of the line of vehicles is 1 km and the spacing changes randomly (as described earlier). The simulation terminated when all vehicles had finished transmitting. Execution time varied between simulations due to varying back off times experienced at each hop.

In the simple flooding case, the per vehicle average transmit interval was 100 ms and the average time between packets sent anywhere in the network was 0.8 ms. Using the present invention, the per vehicle average transmit interval was 1530 ms and average time between packets sent anywhere in the network was 6.5 milliseconds. This represents approximately 10:1 reduction in traffic on the network.

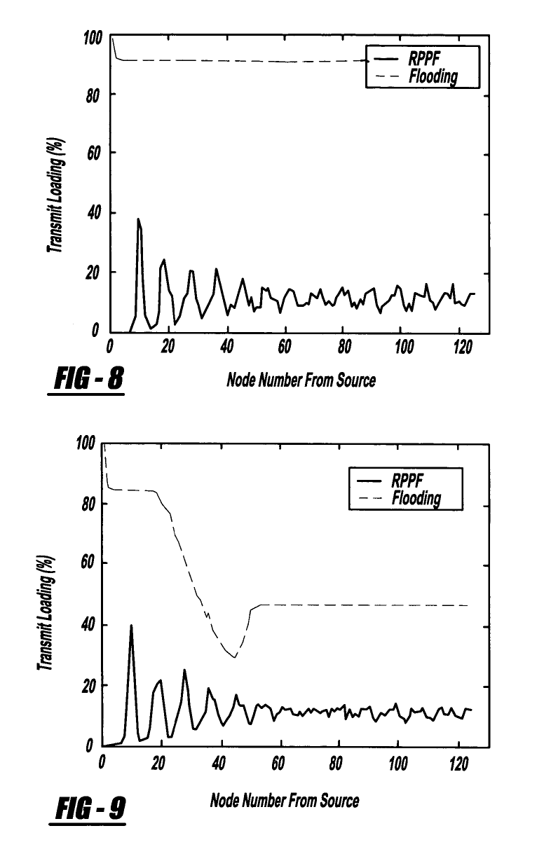

FIG. 8 illustrates how the number of packets sent per vehicle is somewhat cyclic with radio range near the packet source, but further down the road the transmit loading evens out, thereby sharing the cost of transmitting the information. The initial peaks are also likely to result in using a purely distance-based delay.

The same simulation was run at 1 Mbps. In the simple flooding case, the per vehicle average transmit interval was 209 ms and the average time between packets sent anywhere in the network was 1.6 milliseconds. Herein lies the cause for the 54% packet loss seen in FIG. 7.

Using the dissemination method of the present invention, the per vehicle average transmit interval was 1942 ms and average time between packets sent anywhere in the network was again 6.5 milliseconds. This represents approximately 4:1 reduction in traffic on the network, even after the 54% packet loss.

FIG. 9 illustrates the difference in the number of packets each vehicle must transmit between simple flooding and the present invention. The steep drop in transmit loading seen in the simple flooding curve is a result of growing packet loss as the network approaches saturation. This level of contention is not present at 27 Mbps as is evident in FIG. 8. Clear reductions in network loading are realized by the present invention at 1 Mbps. Note in FIG. 8 and FIG. 9 the cyclic nature of the loading near the packet source and how the randomness from the 802.11 DIFS spreads out the loading further away from the packet source. These spikes in loading could be mitigated by some additional randomness in the FDI when the hop count is, for example, less than five.
i=(10×log(pᵣₓ)−10×log(pₘᵢₙ)×tₛ+r
where
i=Flooding Delay Interval (FDI),
pᵣₓ=Receive Power,
pₘᵢₙ=Minimum Receive Power,
tₛ=Spacing Time,
r=Random Delay Offset.

A random delay offset need only be applied to the first re-transmission since subsequent forwarders will be distributed according to a new distribution of receive strength or distance. In addition to reducing the burden on individual vehicles, the further randomness alleviates network dependence on a small number of communication elements and their neighbors.

Performance results for varying packet size, repetition rate and vehicle densities (including sparse vehicle densities) all show the proposed routing protocol provides improved latency times and reduced packet loss; though the amount of improvement in sparse vehicle densities and lightly loaded networks is less remarkable as in dense or heavily loaded networks. Using roadway topologies, the predicted network loading reduction is confirmed by the data presented. Vehicle safety applications such as electronic road signs or emergency messaging are likely to transmit multiple or even continuous copies of the information. This redundancy would mitigate any losses resulting from the protocol performance in non-ideal topologies. The improvements in latency and reliability hypothesized by the reduction in network loading are also evident. Thus, the use of the proposed routing protocol is a more viable routing alternative for vehicle safety communication applications.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for disseminating information in an ad hoc wireless network having a plurality of nodes, comprising:
receiving an incoming message at a recipient node of the network;
scheduling a retransmission of the message, where the schedule time for the retransmission is proportional to a signal strength at which the message was received by the recipient node; and
canceling the retransmission of the message when the same message is received from a different node in the network prior to the schedule time for the retransmission.

2. The method of claim 1 wherein scheduling a retransmission of the message further comprises determining a power level at which the incoming message was received by the recipient vehicle; and determining the schedule time based in part on the power level.

3. The method of claim 2 wherein the schedule time is calculated in accordance with
i=(10×log(pᵣₓ)−10×log(pₘᵢₙ))xtₛ
where i is a delay period before scheduled retransmission, pᵣₓ is the power level at which the message was received, pₘᵢₙ is a minimum power level at which the message can be reliably received at, and tₛ is spacing time for transmitting messages.

4. The method of claim 2 wherein the schedule time is derived from a table, where each row in the table corresponds to a range of signal strengths at which a message was received and correlates each range of signal strengths to an unique schedule time.

5. The method of claim 1 further comprises retransmitting the message at the scheduled time upon failing to receiving the same message from a different node in the network prior to the schedule time.

6. The method of claim 1 wherein the ad hoc wireless network is further defined as an inter-vehicle communication network.

7. The method of claim 1 wherein the ad hoc wireless network is suitable for use in military applications.

8. A method for transmitting data packets amongst a plurality of vehicles in an inter-vehicle communication network, comprising:
receiving a data packet at a recipient vehicle in the network;
scheduling a retransmission of the data packet, where schedule priority given to the data packet correlates inversely to a receive power level associated with the data packet; and
canceling the retransmission of the data packet when an identical data packet is received from a different vehicle in the network prior to the scheduled retransmission of the data packet.

9. The method of claim 8 wherein scheduling a retransmission of the data packet further comprises determining a delay time at which to retransmit the message from the recipient vehicle.

10. The method of claim 9 wherein the delay time is calculated in accordance with
i=(10×log(pᵣₓ)−10×log(pₘᵢₙ))xtₛ
where i is the delay time before scheduled retransmission, pᵣₓ is the power level at which the data packet was received, pₘᵢₙ is a minimum power level at which the data packet can be reliably received at, and tₛ is spacing time for transmitting data packets.
